(19) United States
(12) Patent Application Publication
(10) Pub. No.: US 2015/0161038 A1
(43) Pub. Date: Jun. 11, 2015

(54) System and Method of Operation for High Capacity Solid-State Drive

(71) Applicant: Conversant Intellectual Property Management Inc., Ottawa (CA)

(72) Inventor: Hyun-Woong Lee, Yongin-si (KR)

(73) Assignee: Conversant Intellectual Property Management Inc., Ottawa (CA)

(21) Appl. No.: 14/102,063

(22) Filed: Dec. 10, 2013

(51) Int. Cl. G06F 12/02

(52) U.S. Cl. CPC G06F 12/0246; G06F 2212/7201

(57) ABSTRACT

A method of managing a solid-state drive. The method comprises coupling a flash memory device, serially connected with other flash memory devices to form a channel to further form a high-capacity flash memory structure, to a physical bank of a solid-state drive controller; mapping a logical address from a flash translation layer to a physical bank of the solid-state drive controller; and mapping the address in the physical bank of the solid-state drive controller to a plurality of physical addresses in the flash memory device.

### BACKGROUND

Today's computing devices generally use multiple types of memory systems. For example, one type of memory system is so-called “main memory”, which comprises semiconductor memory devices that can be randomly written to and read from with very fast access times. As such, main memory is commonly referred to as random access memory (RAM).

Since semiconductor memory devices are relatively expensive, other higher density and lower cost memory systems are often used to complement main memory. One such example is a magnetic disk storage system (also called a “hard disk”). Magnetic disk storage systems are used for storing large quantities of data which can then be sequentially read into main memory as needed. However, while data can be stored more cheaply in a hard disk than in RAM, access times are longer, being generally on the order of tens of milliseconds for a hard disk compared to only hundreds of nanoseconds for RAM.

Yet another type of memory system is a so-called solid state disk (also called “solid state drive”, or “SSD”). An SSD is a data storage device that uses memory chips to store data, instead of the spinning platters found in conventional hard disks. SSDs are quite versatile and in fact the term “SSD” can be used to refer to two different kinds of products.

The first type of SSD is based on fast, volatile memory such as, for example, Synchronous Dynamic Random Access Memory (SDRAM), and thus is categorized by very fast data access times. Since such an SSD uses volatile memory, it typically incorporates internal battery and backup disk systems to ensure data persistence. Thus, if power is lost for whatever reason, the battery keeps the unit powered long enough to copy all data from SDRAM to a backup hard disk. Upon the restoration of power, data is copied back from the backup hard disk to SDRAM and the SSD resumes normal operation. This type of SSD is especially useful in accelerating applications that would otherwise be held back by the inherent latency of disk drives.

The second type of SSD uses non-volatile memory, such as, for example, Flash Electrically Erasable Programmable Read Only memory (EEPROM), to store data. Products incorporating this second type of SSD can have the same form factor as conventional mass storage products, and are typically used as low power, rugged replacements for hard disks. To avoid confusion with SSDs of the first type, SSDs of the second type are generally referred to as “Flash” SSDs. The remainder of the present disclosure is directed to Flash SSDs.

A conventional NAND Flash based SSD can consist of several non-volatile NAND-type Flash EEPROM semiconductor integrated circuits with a form factor corresponding to a 3.5″, 2.5″ or 1.8″ hard disk drive (HDD), and/or to a PCIe-based PCB card type in full-length-full-height, half-length-full-height or half-length-half-height form factors. The Flash SSD is connected to a host controller through conventional SATA or PCIe interfaces. Therefore, Flash SSDs are limited by the available number of SATA or PCIe connectors inside the computing system. As a result, the storage capacity provided by conventional NAND Flash based SSDs may be inadequate to meet the ever growing need for large-capacity mass data storage systems brought on by current and future computing applications.

### SUMMARY

In an embodiment, a method of managing a solid-state drive is disclosed. The method comprises coupling a flash memory device, serially connected with other flash memory devices to form a channel to further form a high-capacity flash memory structure, to a physical bank of a solid-state drive controller; mapping a logical address from a flash translation layer to a physical bank of the solid-state drive controller; and mapping the address in the physical bank of the solid-state drive controller to a plurality of physical addresses in a flash memory device.

In an embodiment, a solid-state drive is disclosed. The solid-state drive comprises at least one flash memory device, serially connected in a ring topology to form a unidirectional channel, each flash memory device with a unique identification parameter within the channel. The solid-state drive further comprises a solid-state drive controller to manage mapping between a logical address from a flash translation layer (FTL) and a physical address of the at least one flash memory device. The controller comprises a processor and physical banks coupled to the flash memory devices, with each physical bank having access to a plurality of specific and fixed banks of the at least one flash memory device.

In an embodiment, a method of managing a solid-state drive is disclosed. The solid-state drive comprises mapping a logical address from a flash translation layer to a physical bank of a solid-state drive controller and mapping the address in the physical bank of the solid-state drive controller to a plurality of physical addresses in a flash memory device.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating memory devices according to an embodiment of the present disclosure.

FIG. 2 is a schematic diagram illustrating elements of a high-capacity NAND flash cell array according to an embodiment of the present disclosure.

FIG. 3 is a schematic diagram illustrating a structure of a solid-state drive according to an embodiment of the present disclosure.

FIG. 4 is a schematic diagram illustrating elements of a solid-state drive according to an embodiment of the present disclosure.

FIG. 5 is a schematic diagram illustrating a structure of a solid-state drive according to an embodiment of the present disclosure.

FIG. 6A is a schematic diagram illustrating address mapping of a conventional solid-state drive.

FIG. 6B is a schematic diagram illustrating address mapping of a solid-state drive according to an embodiment of the present disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Against the background provided above, there is clearly a need in the industry for an improved high-capacity mass data storage system that uses non-volatile memories such as NAND flash memories. Embodiments of the present disclosure provide such a high-capacity mass data storage system.

Examples of devices to which the embodiments disclosed herein may be applicable are described in U.S. patent applications U.S. Pat. No. 7,688,652 ‘Storage of Data in Memory via Packet Strobing’, U.S. Pat. No. 7,652,922 ‘Multiple Independent Serial Link Memory’, U.S. Pat. No. 7,515,471 ‘Memory with Output Control’, US2007076502 ‘Daisy Chain Cascading Devices’, US20070143677 ‘Independent Link and Bank Selection’, US20080080492 ‘Packet Based ID Generation for Serially Interconnected Devices’, US20070233917 ‘Device ID in Serially Interconnected Devices”, and US20070234071 ‘Asynchronous ID Generation’. Any such device may be referred to herein as a high-capacity NAND flash device or a high-capacity NAND structure, but it should be understood that such a device may be a type of memory other than NAND.

The high-capacity NAND structure may support any kind of memory including NOR flash, DRAM, or emerging memory. The high-capacity NAND structure may be a unidirectional ring in which data is passed from device to device over point-to-point connections. Each device may add one clock cycle of latency; however the latency may not be an issue in mass storage applications. The latency around the ring may be less than 1% of the time it takes to read or write the flash memory device. The high-capacity NAND structure commands may be used to direct the high-capacity NAND memory devices to perform various operations, such as page read, page program, or block erase. The commands may be embedded in a serial data stream that is transferred from a host controller to the memory devices via a serial bus defined as the high-capacity NAND link. Parameters that are associated with the command, such as addresses or data, may also be included in the serial stream. The command and parameter information may be “tagged” with codes so that the command and parameter information may be identified by the memory devices. For example, a two-bit code may precede a command in the serial stream to indicate that the information following the code is a command. Likewise, data and address information may each be preceded in the stream with codes to identify this information.

Problems may be caused when the unique address structure of high-capacity NAND flash devices is implemented with the conventional flash translation layer (FTL). The conventional flash translation layer is optimized for conventional NAND flash memory devices, for example open NAND flash interface (ONFI) or toggle mode based NAND flash devices. Thus, the addresses of the high-capacity NAND flash devices may not be implemented with the flash translation layer directly. The present disclosure teaches a system and method for grouping addresses of the high-capacity NAND flash devices to take advantage of the existing flash translation layer. The method may allow the flash translation layer to maximize the existing methodology when the conventional NAND address scheme and the high-capacity NAND address scheme are transformed by an FTL-driven structural approach.

For example, high-capacity NAND flash devices may be connected in a serially connected, point-to-point, ring topology to form a channel. Signals may propagate on the serially connected ring topology in a unidirectional manner. A first high-capacity NAND flash device is configured to receive an input of serial data and to provide an output of serial data, and a second high-capacity NAND flash device is configured to receive the output of serial data from the first high-capacity NAND flash device. The first high-capacity NAND flash device in the serially connected ring topology has a first device identification number that allows a first portion of the serial data to be addressed to the first flash memory device, and the second high-capacity NAND flash device in the serially connected ring topology has a second device identification number that allows a second portion of the serial data to be addressed to the second NAND flash memory device.

A logical bank from the flash translation layer may be coupled to a physical bank in a solid-state drive controller on a one-to-one basis. The physical bank in the solid-state drive controller may be coupled to more than one specific and fixed bank in a high-capacity NAND flash device. Conventional NAND based systems may only have a limit of up to eight physical NAND expansions per channel. High-capacity NAND based systems may be expanded up to 255 NAND flash devices without physical difficulties such as signal distortion. Therefore, the high-capacity NAND system may be optimized for mass storage systems with large capacities.

Memory devices may be provided as internal, semiconductor, integrated circuits in computers or other electronic devices. There are many different types of memory, including volatile and non-volatile memory. Volatile memory may require power to maintain its data and may include random access memory (RAM), dynamic random access memory (DRAM), and synchronous dynamic random access memory (SDRAM), among others. Non-volatile memories may provide persistent data by retaining stored information when not powered and may include NAND flash memory, NOR flash memory, read only memory (ROM), electrically erasable programmable ROM (EEPROM), erasable programmable ROM (EPROM), and phase change random access memory (PCRAM), among others.

Non-volatile flash memory devices may be classified as NOR devices or NAND devices. The classification may be based on the way the individual memory cells are interconnected within an array of cells. NOR devices are random access. That is, a host computer accessing a NOR flash device may provide the device any address on its address pins and immediately retrieve data stored in that address on the device's data pins. This is similar to the manner in which static RAM (SRAM) or EPROM memories operate. NAND devices, on the other hand, may not be random access but serial access. With NAND devices, it may not be possible to access any random address in the way described above for NOR. Instead, the host may have to write into the device a sequence of bytes which identifies both the type of the requested command (e.g., read, write, erase, etc.) and the address to be used for that command. The address identifies a page (the smallest chunk of flash memory that may be written in a single operation) or a block (the smallest chunk of flash memory that may be erased in a single operation). While the read and write command sequences may contain addresses of single bytes or words, the NAND flash device may read complete pages from the memory cells and write complete pages to the memory cells. After a page of data is read from the array into a buffer inside the device, the host may access the data bytes or words one by one by serially clocking them out using a strobe signal.

Because of the non-random access of NAND devices, NAND devices may not be used for running code directly from the flash memory. However, NOR devices may support direct code execution (typically called “eXecution In Place” or “XIP”). Therefore, NOR devices may be the memory type used for code storage. NAND devices may be useful for data storage. NAND devices may be cheaper than NOR devices of the same bit capacity, further, NAND devices may provide many more bits of storage than NOR devices for the same cost. Also, the write and erase performance of NAND devices may be significantly faster than that of NOR devices. Thus, NAND flash memory technology may be used for storing data.

Memory devices may be combined to form a solid-state drive (SSD). An SSD may include non-volatile memory, e.g., NAND flash memory and NOR flash memory, and/or may include volatile memory, e.g., DRAM and SRAM, among various other types of non-volatile and volatile memory.

An SSD may be used to replace a hard disk drive as the main storage device for a computer, as the SSD may outperform hard drives in terms of, for example, performance, size, weight, ruggedness, operating temperature range, and power consumption. For example, SSDs may have superior performance when compared to magnetic disk drives due to their lack of moving parts, which may ameliorate seek time, latency, and other electro-mechanical delays associated with magnetic disk drives. SSD manufacturers may use non-volatile flash memory to create flash SSDs that may not use an internal battery supply, thus allowing the drive to be more versatile and compact. SSDs used as a storage device may include, for example, a fast access rate, a high integration density, and stability against external impact. Furthermore, manufacturing technologies for SSDs may reduce the production costs of SSDs and increase the storage capacities of SSDs.

An SSD may include a number of memory devices, e.g., a number of memory chips. (As used herein, the term “a number of” something may refer to one or more such things. For example, a number of memory devices may refer to one or more memory devices). A memory chip may include a number of dies. Each die may include a number of memory arrays and peripheral circuitry thereon. A memory array may include a number of planes, with each plane including a number of physical blocks of memory cells. Each physical block may include a number of pages of memory cells that may store a number of sectors of data.

Commands, such as program commands, read commands, and erase commands, among other commands, may be used during operation of an SSD. For example, a program, e.g., write, command may be used to program data on an SSD, a read command may be used to read data on an SSD, and an erase command may be used to erase data on an SSD.

When an SSD is used as a storage device in a computer system or a portable device, a control device may be used to manage data transfer between a host and a flash memory. Computer systems may use an advanced technology attachment (ATA) protocol by IBM Inc. and an interface compatible with the ATA protocol to transfer data to and from a large-capacity storage device, such as a hard disk drive. If computer systems adopt the SSD as the large-capacity storage device, the computer systems may need to have an interface capable of transferring data to and from the flash memory in a manner compatible with the ATA protocol. Hereinafter, a device for controlling overall operations related to data transfer to and from an SSD may be referred to as an SSD controller.

NAND flash memory devices may use the same electrical signals for coordinating commands and data transfer between the NAND flash device and a host device. Such signals may include data lines and a number of control signals, such as ALE (Address Latch Enable), CLE (Command Latch Enable), WE# (Write Enable), and others. This type of interface protocol may be referred to as “NAND interface”. Even though the “NAND interface protocol” may not be formally standardized by a standardization body, the manufacturers of NAND flash devices may follow the same protocol for supporting the basic subset of NAND flash functionality. Thus, customers using NAND flash memory devices within their electronic products may use NAND flash memory devices from any manufacturer without having to tailor their hardware or software for operating with the devices of a specific vendor. In some cases, NAND flash memory vendors that provide extra functionality beyond the basic subset of functionality described above may ensure that the basic functionality is provided in order to provide compatibility with the protocol used by the other vendors, at least to some extent.

Operating and using a NAND flash memory device directly by a host device with no intervening NAND controller may be possible. In these cases, the host may have to individually manipulate each one of the NAND flash memory device's control signals (e.g., CLE or ALE), which may be cumbersome and time-consuming for the host. Further, the support of error detection code (EDC) and error correction code (ECC) may put a severe burden on the host, since parity bits may have to be calculated for each page written, and error detection calculations (and sometimes also error correction calculations) may be performed by the host. Such factors may make such a “no controller” architecture relatively slow and inefficient.

Because of complexities related to NAND flash memory devices, a “NAND flash memory controller” may be used for controlling the use of a NAND flash memory device in an electronic system. Using a NAND flash memory controller may significantly simplify the host's tasks when using a NAND flash memory device. The processor may interact with the controller using a protocol that is much more convenient to use. For example, a request for writing a page may be sent as a single command code followed by an address and data instead of the need for complex sequencing of control lines and NAND command codes. The controller may then convert the host-controller protocol into the equivalent NAND protocol sequences, while the host may be free to do other tasks or wait for the NAND operation to complete, if so desired.

In some cases, serial in/out data pins (SIP for ‘Serial Input Port’ and SOP for ‘Serial Output Port’) along with two control signals (IPE & OPE) may be used for the enabling and disabling of a serial input port (IPE) and a serial output port (OPE), respectively, in order to provide a memory controller with flexibility in serial data communication. In some cases, instead of the names SIP/SOP/IPE/OPE, the names D[0:7]/Q[0:7]/CSI/DSI, respectively, may be used, but the functionality of the signals is the same. In these cases, the CSI (or IPE) signal may control both ‘command/address’ input and ‘write-data’ input, while the DSI (or OPE) signal may control only a ‘read-data’ output. Therefore, the command/address control signal and the data control signal may not be fully flexible in terms of independence of operation, and the mixed scheme of serial command/address signals with serial input data signals may not be considered a true dedicated controlling of memory system operations.

In some cases, a fully serialized, high-speed, serial link of in/out pins (D[0:7] for Serial Data Input Port, Q[0:7] for Serial Data Output Port) along with two dedicated control signals (CSI for Command/Address Packet only, DSI for Write & Read Data Packet) for the enabling and disabling of ‘command/address packet’ and ‘data packet’, respectively may be used.

Flash memory may be divided into multiple memory blocks, with each block comprising multiple memory pages. Data may be written and read in page units but erased in block units, which may also be referred to as physical blocks or erasure blocks. Data may not be overwritten in-place. That is, a new page may not overwrite an old page in the same physical location unless the entire block is erased first. As a result of these characteristics, data storage in flash memory may involve management functions that may be referred to collectively as Flash Translation Layer (FTL). The flash translation layer may preserve data when a sudden power-off occurs during flash translation layer operations. Additionally, the flash translation layer may have the functionality to wear down memory blocks evenly. While a high-capacity NAND flash device structure is used throughout as an example and preferred embodiment, it is understood that the teachings of the disclosure may be applied to other types of solid-state drive.

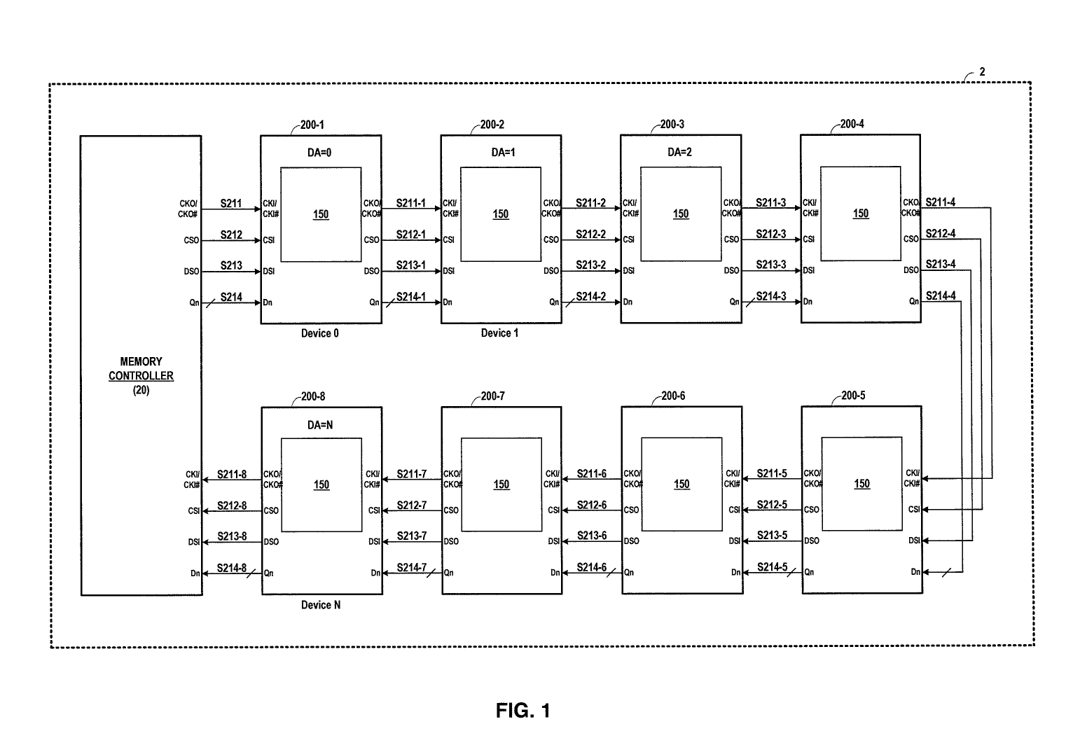

Turning now to FIG. 1, a high-capacity NAND device configuration 2 is described. In an embodiment, the device configuration 2 may comprise a plurality of high-capacity NAND devices 200, for example device 0-N, configured in a serially connected ring topology arrangement. Signals may be transmitted serially through the devices 200 in a unidirectional manner. For example, signals from a solid-state drive controller 20 may be input into the input ports of a first device, for example Device 0. The output signals of a previous device 200 may be input into the input ports of the next device 200 of the daisy chain. For example, the output signals of Device 0 may be input into the input ports of Device 1. The output signals from the last device 200 of the chain may be input back to the solid-state drive controller 20. It should be noted that although eight devices 200 are shown in FIG. 1, any number up to 255 of the devices 200 may be serially connected to form a channel.

The devices are illustratively memory devices each of which may comprise a memory (not shown) which may comprise static random access memory (SRAM) cells, dynamic random access memory (DRAM) cells, NAND flash memory cells, NOR flash memory cells, or another kind of memory cells.

A device may comprise a clock input port CK, a clock output port CKO, a source-synchronous clock input port CK#, a source-synchronous clock output port CKO#, a chip enable input port CE#, 8-bit serial input ports D[0:7], 8-bit serial output ports Q[0:7], an input port enable port CSI, an input port enable output port CSO, an output port enable port DSI, an output port enable output port DSO, or another signal port. The CK may be used to provide a clock signal to the device and the CE# may be used to provide a chip enable input signal to a device. The CKO may be used to output a clock signal from an earlier device in the serially connected ring topology to the next device in the serially connected ring topology. The CK# may be used to input a source synchronous clock signal to a device. The CKO# may be used to output a regenerated clock signal to the next device in the serially connected ring topology.

The CSI may be used to input a CSI signal, an input port enable signal, to the device. For example, the CSI may be used to enable input signals via D[0:7], D0 through D7, to the device. For example, when CSI is asserted, information may be serially input to the device via D[0:7]. The DSI may be used to enable signal output via Q[0:7]. For example, when DSI is asserted, information may be serially output via Q[0:7], Q0 through Q7, to the next device in the serially connected ring topology. The CSO and DSO may be output ports that output CSI and DSI signals respectively to the next device in the serially connected ring topology. The CSO may be a delayed signal of CSI, or a derivative of the CSI signal. Similarly, the DSO may be a delayed signal of DSI, or a derivative of the DSI signal.

The chip enable input CE# of each device may be a conventional chip enable that enables/selects the device. The input of CE# of each device may be coupled to a common link which enables a chip enable signal to be asserted to all the devices coupled to the common link.

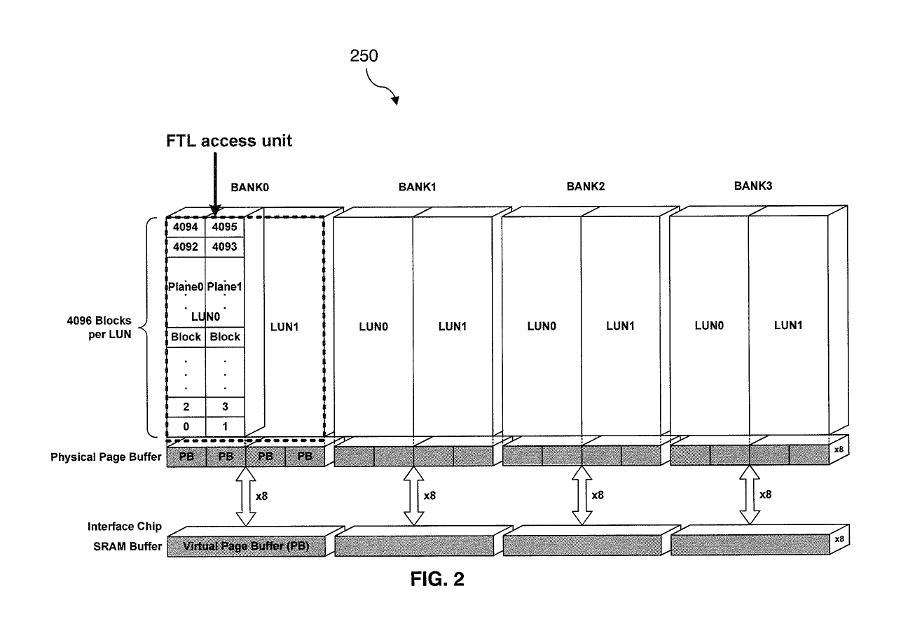

Turning now to FIG. 2, a high-capacity NAND flash memory device 250 is described. In an embodiment, the high-capacity NAND flash memory device 250 may comprise a plurality of memory banks each of which may comprise a plurality of logical units (LUNs). Each LUN may comprise a plurality of planes or blocks. One block may comprise a plurality of pages, each of which may comprise some number of bytes of data. Thus, a page address in a high-capacity NAND flash device may have the hierarchy of BANK/LUN/BLOCK/PAGE and comprise the bank, the LUN, the block, and the page addresses. A physical page buffer and a virtual page buffer may comprise some number of bytes of data. The smallest unit for the flash translation layer to access may be a bank, as shown in FIG. 2.

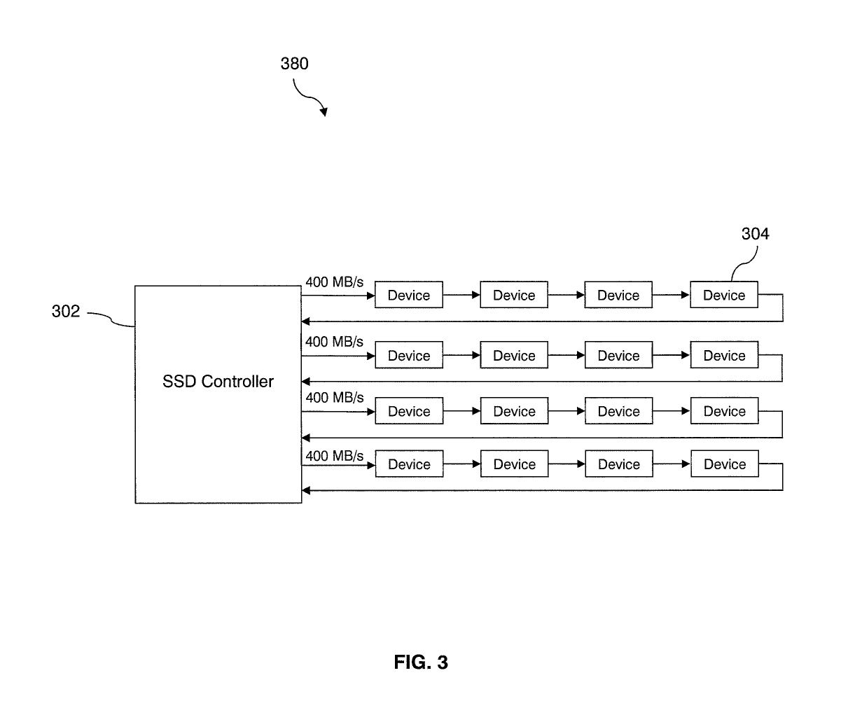

Turning now to FIG. 3, a solid-state drive 380 is described. In an embodiment, a solid-state drive controller 302 may support up to eight channels. The data rate on each channel may go up to several hundred megabytes per second, for example 200 MB/s, 300 MB/s, 400 MB/s, or another data rate. A plurality of flash memory devices 304 may be coupled in a serially connected ring topology arrangement for each channel. In some embodiments, up to 255 flash memory devices 304 may be coupled in such a manner. Each flash memory device 304 may have a unique device identification number within the channel. It should be noted that although four channels are shown in FIG. 3, up to eight channels may be supported by the solid-sate drive controller 302 in a solid-state drive comprising high-capacity NAND devices.

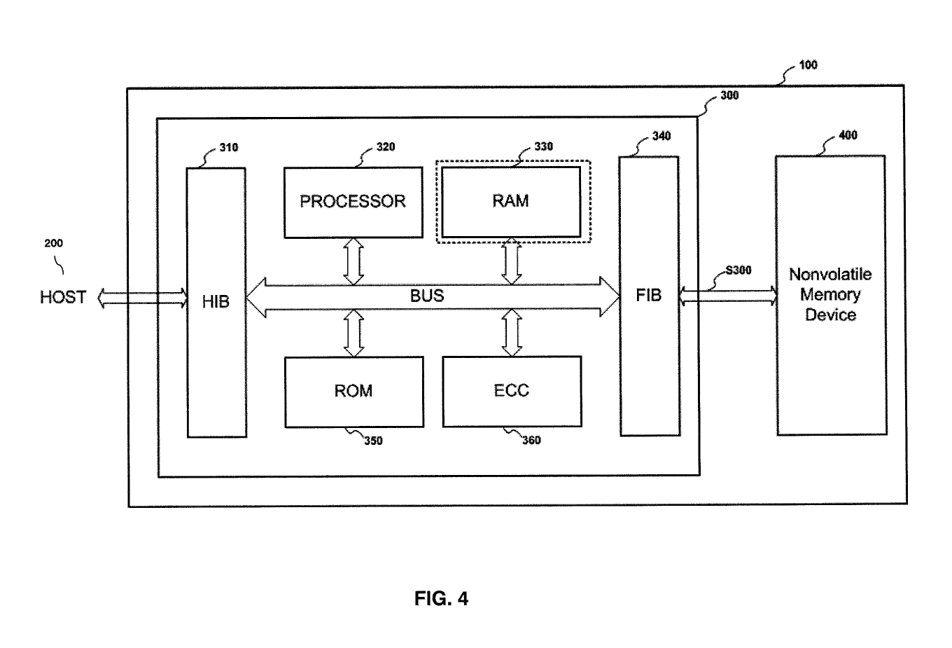

FIG. 4 shows a block diagram of a solid-state storage device 100. In an embodiment, the solid-state storage device 100 comprises a non-volatile memory controller 300 and nonvolatile memory device 400. The non-volatile memory controller 300 may control exchange of data between a host 200 and the nonvolatile memory device 400. The non-volatile memory controller 300 may comprises a host interface block (HIB) 310, a central processor unit 320, a random access memory (RAM) 330, a flash memory interface block (FIB) 340, a read only memory (ROM) 350, and an error correction code (ECC) engine 360. The non-volatile memory controller 300 may operate a flash translation layer (FTL) embodied as software or firmware. The RAM 330 may be located outside of the non-volatile memory controller 300.

The non-volatile memory controller 300 may control overall operations of the solid-state drive 100 and may control the exchange of data between the host 200 and the nonvolatile memory device 400. For example, the non-volatile memory controller 300 may control the nonvolatile memory device 400 to write data or to read data in response to a request from the host 200. Also, the non-volatile memory controller 300 may control internal operations, for example performance control, merging, wear leveling, or another internal operation, which are desirable for the characteristics of nonvolatile memory device 400 or for efficient management of the nonvolatile memory device 400. The non-volatile memory controller 300 may drive firmware and/or software for controlling operations of the nonvolatile memory device 400, which is referred to as a flash translation layer (FTL) (not shown). The non-volatile memory controller 300 may control the nonvolatile memory device 400 to control operations of a number of nonvolatile memories from among the multiple nonvolatile memories included in the nonvolatile memory device 400, based on a request from the host 200. The nonvolatile memory device 400 may provide a storage medium for storing data in a nonvolatile manner. For example, the nonvolatile memory device 400 may store an operating system (OS), various programs, various multimedia data, or another kind of data.

The host interface block 310 may receive information, for example data, address information, external commands, or other information from the host 200. Also, the host interface block 310 may send information, for example data, status information, or other information to the host 200. The external command may be for the host 200 to control the memory controller 300. Data and/or other information supplied from the host 200 to the solid-state storage device 100 may be input into functional blocks included in the solid-state storage device 100, for example the buffer RAM 330, through the host interface block 310 as an inlet for data. Also, data and/or other information supplied from the solid-state storage device 100 to the host 200 may be supplied through the host interface block 310 as an outlet for data.

In an embodiment, the central processor 320 reads program code from the ROM 350 or the nonvolatile memory device 400, and controls all functional blocks included in the controller 300 according to the read program code. The program code may specify operating parameters of the central processor 320. The central processor 320 may control access to the nonvolatile memory device 400 on a basis of the read program code. Additionally, the program code stored in the nonvolatile memory device 400 is read from the nonvolatile memory device 400 and written to the RAM 330 when the solid-state storage device 100 is booted.

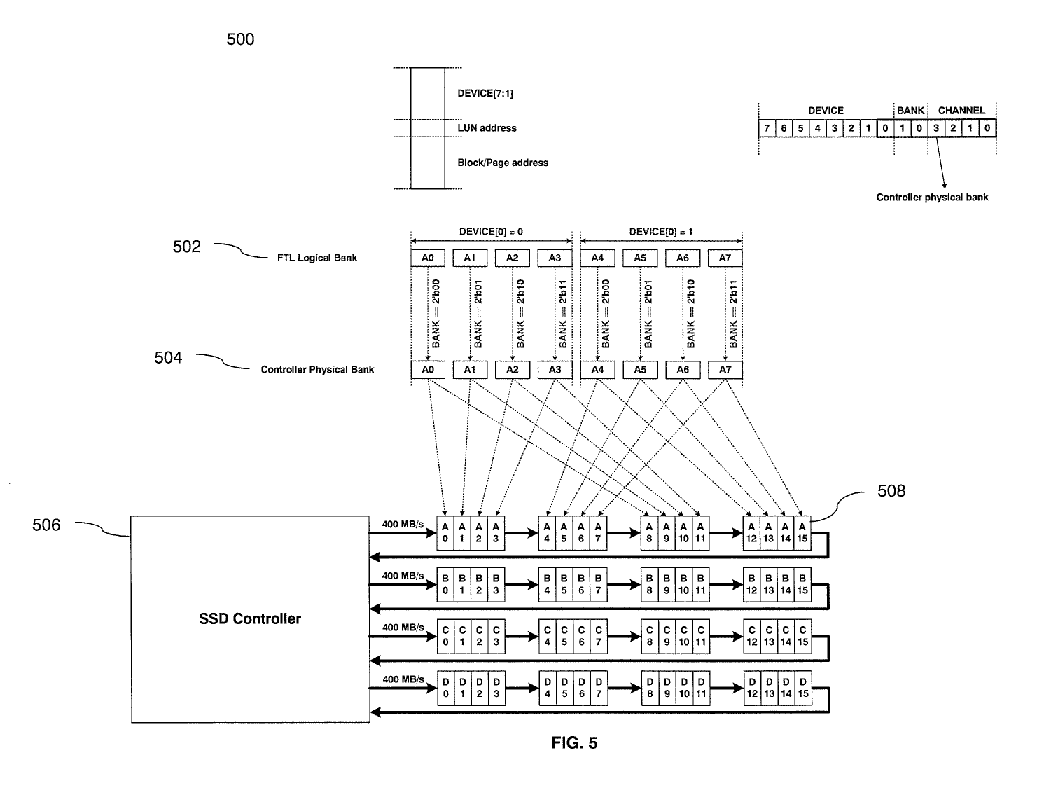

FIG. 5 shows the mapping among flash memory devices, a flash translation layer, and a solid-state drive controller 506. An FTL logical bank 502 may include a plurality of logical addresses, labeled A0 through A7. The FTL logical banks A0-A7 may constitute two logical devices, device 0 and device 1. A solid-state drive controller physical bank 504 may include a plurality of physical addresses, also labeled A0 through A7. An individual logical address A0 through A7 or an individual physical address A0 through A7 may also be referred to as a block or a bank. Although shown outside the controller 506, the controller physical bank 504 may be a component within the controller 506. A logical address in the FTL logical bank 502 may be mapped on a one-to-one basis to a physical address in the solid-state drive controller physical bank 504. In an embodiment, an address in the solid-state drive controller physical bank 504 may be mapped to a plurality of NAND devices, labeled A0 through A15, in a bank 508 in the flash memory. An individual NAND device may also be referred to as a bank of memory, and a set of serially connected NAND devices, such as NAND devices A0 through A15 in bank 508, may also be referred to as a channel or a flash memory device.

When a read or write operation is conducted by a host, a logical address corresponding to a logical bank 502 in the flash translation layer may be generated by the flash translation layer based on the logical address given by the host. Since the logical bank 502 in the flash translation layer is coupled to a physical bank 504 in the solid-state drive controller, the address in the logical bank 502 in the flash translation layer may be mapped to an address corresponding to the matching physical bank 504 in the solid-state drive controller. Since the physical bank 504 in the solid-state drive controller is coupled to banks in the flash memory devices 508, the address in the physical bank 504 in the solid-state drive controller may be mapped to an address in one of the matching banks in the flash memory devices 508 based on predefined rules.

For example, a logical address from a host device may be mapped to a physical address in a flash memory device 508. The logical address from the host device may first be mapped to an address in the FTL logical bank 502 by a flash translation layer embedded as firmware and/or software in the solid-state drive controller 506. An address in the FTL logical bank 502 may then be mapped to an address in the solid-state drive controller physical bank 504 by the solid-state drive controller 506. Finally, an address in the solid-state drive controller physical bank 504 may be mapped to a plurality of banks in the flash memory device 508.

Each FTL logical bank 502 may be coupled to one solid-state drive controller physical bank 504 on a one-to-one basis. In other words, each solid-state drive controller physical bank 504 may be coupled to only one FTL logical bank 502. For example, the flash translation layer may be configured to comprise eight logical banks 502 to couple to the eight solid-state drive controller physical banks 504. In an embodiment, each solid-state drive controller physical bank 504 may be coupled to more than one flash memory device in the bank 508. In other words, more than one flash memory device in the bank 508 may be coupled to the same solid-state drive controller physical bank 504.

In an embodiment, the coupling between the solid-state drive controller physical bank 504 and the flash memory device banks 508 is fixed after configuration. For example, once configured, solid-state drive controller physical bank A0 may be coupled to two fixed flash memory device banks, such as A0 and A8, and may remain fixed to those devices. That is, controller physical bank A0 may not be coupled to flash memory device banks A0 and A8 for a first operation and then flash memory device banks A0 and A1, for example, for a second operation.

The solid-state drive controller physical banks 504 may be physical banks in the solid-state drive controller 506. The solid-state drive controller 506 typically comprises a limited number of physical banks, such as eight physical banks. It may be desirable for a solid-state drive controller physical bank 504 to be coupled to NAND devices in a flash memory device bank 508 on a one-to-one basis. In other words, for each NAND device in the flash memory device bank 508, it may be preferable for one solid-state drive controller physical bank 504 to exist to be coupled to one device in the flash memory device bank 508. However, due to technical and resource limitations, only a limited number of physical banks 504 may be built in the solid-state drive controller 506. Since the controller 506 may have only eight physical banks and high-capacity NAND devices may have more than eight memory banks, a one-to-one mapping between physical banks and memory banks may not be possible in a high-capacity NAND device. In an embodiment, the coupling between solid-state drive controller physical banks 504 and flash memory device banks 508 may be configured on a one-to-many basis.

The flash memory devices may be connected in a daisy chain to form a channel. In an embodiment, the solid-state drive controller 506 may comprise up to eight channels. Signal propagation on the daisy chain may be unidirectional. Each flash memory device may be assigned with a unique identification number within the channel. A first flash memory device in the serially connected ring topology has a first device identification number that allows a first portion of serial data to be addressed to the first flash memory device, and a second flash memory device in the serially connected ring topology has a second device identification number that allows a second portion of the serial data to be addressed to the second flash memory device. For example, the first flash memory device in the serially connected ring topology may check the destination address information propagating on the daisy chain to decide whether the corresponding information, for example command code, data, or other information, is sent to the first flash memory device. Information transmitted on the daisy chain that is sent to the first flash memory device may be truncated from the serial signal. Following flash memory devices in the serially connected ring topology after the first flash memory device may not receive the truncated information so that the bandwidth may be saved.

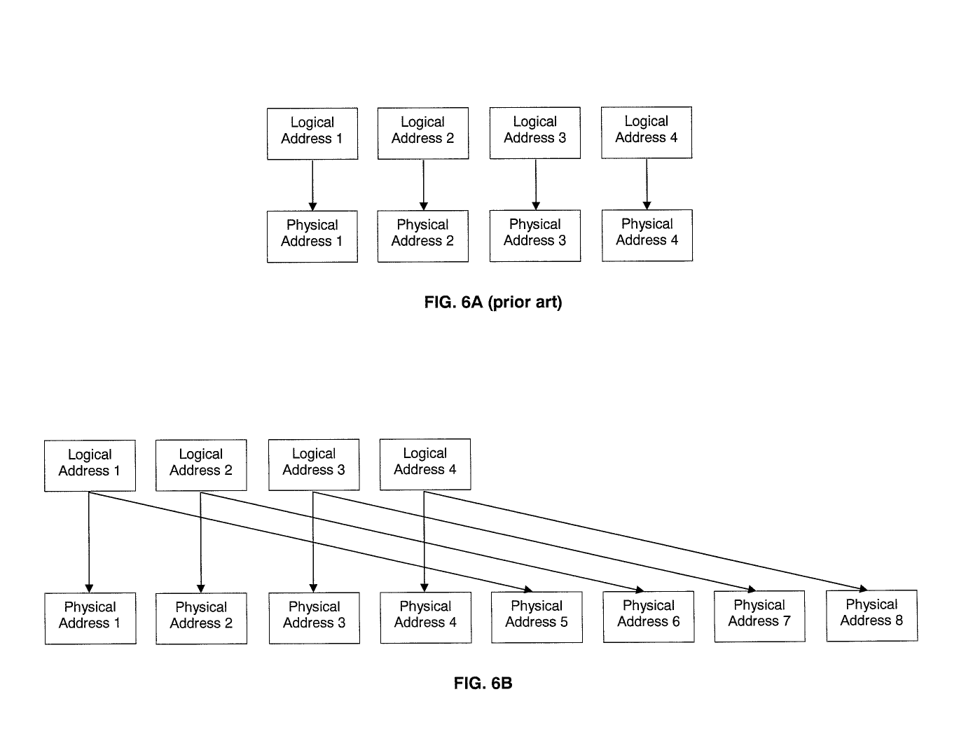

FIGS. 6A and 6B show a comparison of the coupling of logical addresses and physical addresses between conventional solid-state drives and an embodiment of this disclosure. FIG. 6A shows the coupling between logical addresses and physical addresses of conventional solid-state drives. The coupling may be made on a one-to-one basis. FIG. 6B shows the coupling between logical addresses and physical addresses of an embodiment of this disclosure. The coupling may be made on a one-to-many basis. That is, a single logical address may be coupled to more than one physical address in a flash memory device. While FIG. 6B depicts one logical address coupled to two physical addresses, it should be understood that one logical address may be coupled to more than two physical addresses, and the coupling may occur in other configurations than those shown.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made without departing from the spirit and scope disclosed herein.

What is claimed is:

1. A method of managing a solid-state drive, comprising:
coupling a flash memory device, serially connected with other flash memory devices to form a channel to further form a high-capacity flash memory structure, to a physical bank of a solid-state drive controller;
mapping a logical address from a flash translation layer to a physical bank of the solid-state drive controller; and
mapping a single logical address in the physical bank of the solid-state drive controller to more than one physical address in the flash memory device.

2. The method of claim 1, wherein the flash memory device is a NAND flash device.

3. The method of claim 1, wherein the solid-state drive controller supports up to eight channels.

4. The method of claim 1, wherein each flash memory device has a unique device identification number within the channel.

5. The method of claim 1, wherein the channel has a capacity of up to 255 serially connected flash memory devices.

6. The method of claim 1, wherein the coupling of a physical bank of the solid-state drive controller and a specific physical bank of the flash memory devices is fixed after configuration.

7. The method of claim 1, wherein the signal propagation is unidirectional along the serially connected flash memory devices.

8. A solid-state drive, comprising:
at least one flash memory device, serially connected in a ring topology to form a unidirectional channel, each flash memory device with a unique identification parameter within the channel; and
a solid-state drive controller to manage mapping between a logical address from a flash translation layer (FTL) and a physical address of the at least one flash memory device, the controller comprising:
a processor, and
physical banks coupled to the flash memory devices, with each physical bank having access to a plurality of specific and fixed banks of the flash memory device.

9. The solid-state drive of claim 8, wherein a first flash memory device in the serially connected ring topology has a first device identification number that allows a first portion of serial data to be addressed to the first flash memory device, and wherein a second flash memory device in the serially connected ring topology has a second device identification number that allows a second portion of the serial data to be addressed to the second flash memory device.

10. The solid-state drive of claim 8, wherein the flash memory device is a NAND flash device.

11. The solid-state drive of claim 8, wherein a physical address within a channel in the flash memory devices comprises a bank address, a logical unit (LUN) address, a block address, and a page address.

12. The solid-state drive of claim 8, wherein a device address, a bank address, and a logical unit address of an address of the flash memory device are coupled to a physical bank of the solid-state drive controller.

13. A method of managing a solid-state drive, comprising:
mapping a logical address from a flash translation layer to a physical bank of a solid-state drive controller; and
mapping the address in the physical bank of the solid-state drive controller to a plurality of physical addresses in a flash memory device.

14. The method of claim 13, wherein a plurality of flash memory devices are serially connected in a unidirectional ring topology.

15. The method of claim 14, wherein a first flash memory device is configured to receive an input of serial data and to provide an output of serial data, and wherein a second flash memory device is configured to receive the output of serial data from the first flash memory device.

16. The method of claim 15, wherein the first flash memory device has a first device identification number that allows a first portion of the serial data to be addressed to the first flash memory device, and wherein the second flash memory device has a second device identification number that allows a second portion of the serial data to be addressed to the second flash memory device.

17. The method of claim 13, wherein a logical bank from the flash translation layer is mapped to a physical bank of the solid-state drive controller on a one-to-one basis.

18. The method of claim 13, wherein a physical bank of the solid-state drive controller is mapped to at least one bank of a flash memory device on a one-to-many basis.
